(19) United States
(12) Patent Application Publication
(10) Pub. No.: US 2025/0346508 A1
(43) Pub. Date: Nov. 13, 2025

(54) VESSEL / RESERVOIR FOR DISINFECTANT STORAGE

(71) Applicant: Mark N. Chaffin, Wallis, TX (US)

(72) Inventor: Mark N. Chaffin, Wallis, TX (US)

(21) Appl. No.: 18/658,992

(22) Filed: May 9, 2024

(51) Int. Cl. C02F 1/50

(52) U.S. Cl. CPC C02F 1/50; C02F 2201/004; C02F 2303/04

(57) ABSTRACT

An apparatus for dispensing disinfectant comprising a disc-shaped reservoir having an internal volume. a surface section is integrally coupled to and positioned substantially perpendicular to a wall section. A bottom section is integrally coupled to and positioned substantially perpendicular to the wall section. A cylindrical filler neck is coupled to the surface section. A first reveal is integrally coupled to the wall section. A second reveal is integrally coupled to the wall section and positioned substantially 90 degrees from the first reveal. A third reveal is integrally coupled to the wall section and positioned substantially 180 degrees from the first reveal and substantially 90 degrees from the second reveal. A fourth reveal is integrally coupled to the wall section and positioned substantially 90 degrees from the third reveal and 270 degrees from the first reveal.

### BACKGROUND

Storage-mixing tanks and wastewater disposal systems are used for managing the wastewater effluent in septic systems for residences and other small volume establishments; especially for conditions when it is not possible or practical to achieve connection to a municipal sewage treatment system. Providing routine maintenance to storage-mixing tanks can be cumbersome and dangerous. Issues such as draining the storage-mixing tank, flushing the disposal system, and replenishing the disinfectant supply can result in personal injury or contamination. For example, conventional tablet disinfectant dispensing systems are placed deep inside the storage-mixing tank and accessing them creates potential safety hazards for individuals. Having a conveniently accessible disinfectant dispensing system that mitigates safety hazards while easing maintenance is a challenge.

### BRIEF DESCRIPTION OF THE DRAWINGS

FIG. 1 is a profile view of a disc-shaped reservoir for storing disinfectant to be dispensed.

FIG. 2 is a perspective view of a disc-shaped reservoir for storing disinfectant to be dispensed.

FIG. 3 is an aerial view of a disc-shaped reservoir for storing disinfectant to be dispensed.

FIG. 4 is a cut-out perspective view of a disc-shaped reservoir for storing disinfectant coupled to a wastewater treatment tank access riser.

FIG. 5 is a perspective view of the disc-shaped reservoir twist lock section.

FIG. 6 is a cross-sectional view of a venturi for a liquid disinfectant dispensing system.

FIG. 7 is a semi-translucent profile view of wastewater treatment system for septic systems having a wastewater treatment tank access riser, a disc-shaped reservoir for storing disinfectant, a venturi for a liquid disinfectant dispensing system, and a pump.

FIG. 8 is a flow chart illustrating a method for implementing and operating a wastewater treatment system for septic systems.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein. Further, the term “substantially” as used in this disclosure and claims is defined as having a measurement that may be 1, 5, or 10 degrees off from the claimed measurement. For example, when a statement is made that a first embodiment is substantially perpendicular to a second embodiment, this means that the first embodiment may not be perfectly perpendicular (i.e., exactly 90 degrees) to the second embodiment, but within the range of one to ten degrees offset of the 90 degrees (i.e., between 100 degrees or 80 degrees offset).

Storage-mixing tanks and wastewater disposal systems are used for managing the wastewater effluent in septic systems for residences and other small volume establishments. These devices are especially used for situations when it is not possible or practical to achieve connection to a municipal sewage treatment system. As defined herein, the term “residential septic system” or other variations is intended to encompass any small volume wastewater treatment system whether residential or not, where sewage effluent is treated and is ultimately conducted to a subsurface drainage field or spray field, permitting its absorption into the soil.

An aerobic wastewater system incorporates a series of tanks or vessels which may be located above ground, below ground, or partly exposed above ground. The tank or vessel of the apparatus described herein is typically known as a storage-mixing tank, which receives clarified but still bacteria-laden sewage effluent discharge of the home or other building. A pump is typically located within the storage-mixing tank and periodically is energized for pumping collected wastewater to a drainage field or spray field for sanitary disposal. The wastewater entering a typical aerobic wastewater storage-mixing tank is caused to flow across a chamber containing a chlorine compound in tablet form so that the wastewater dissolves the compound, and thereby is disinfected by absorbed chlorine before disposal within the drainage field or spray field.

This configuration requires the individual owners to manage the effluent disposal and maintenance of their storage-mixing tanks. Unfortunately, providing such routine maintenance to their storage-mixing tanks can be cumbersome and very dangerous. Issues such as pumping or draining the storage-mixing tank, flushing the disposal system, and replenishing the disinfectant within the dispensing system can result in personal injury or contamination. For example, standard tablet disinfectant dispensing systems are placed deep inside the storage-mixing tank and accessing them creates potential safety hazards for individuals.

Major injury or death may also occur when the plate cover (i.e., storage-mixing tank lid) is not properly secured to the storage-mixing tank which could result in an individual falling into the storage-mixing tank. The embodiments described herein are of an apparatus and method that provides a more convenient and safer way of refilling the disinfectant dispensing system. In addition, the apparatus and method also serve as a secondary-safety device that restricts access to the interior of the storage-mixing tank notwithstanding the plate cover.

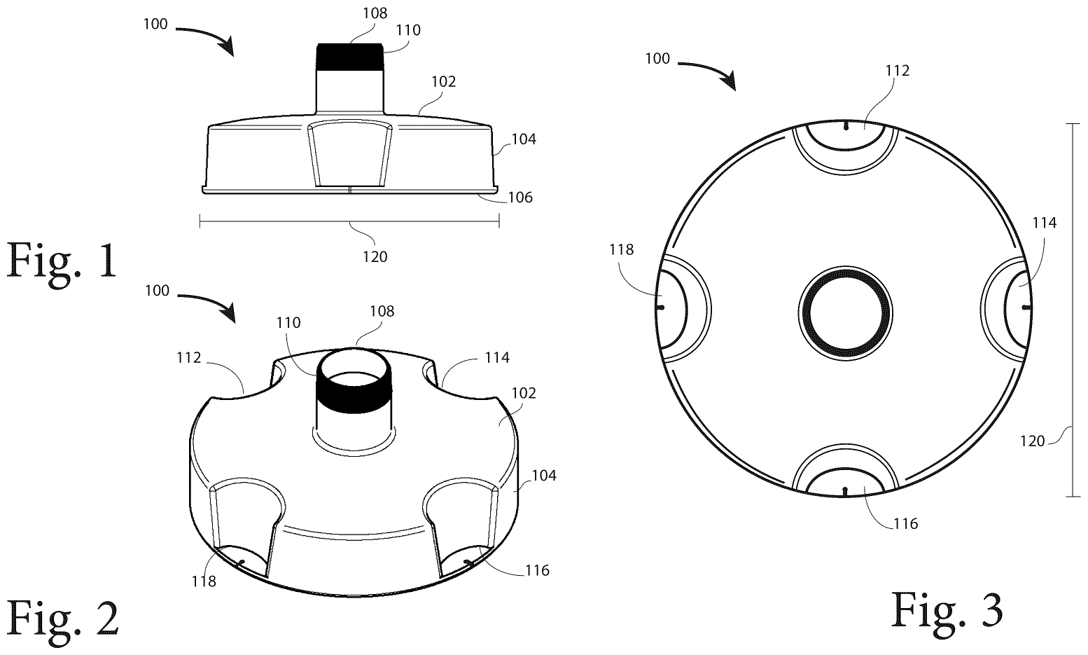

For example, FIG. 1 is a profile view of a disc-shaped reservoir for storing disinfectant. FIG. 2 is a perspective view of a disc-shaped reservoir for storing disinfectant, and FIG. 3 is an aerial view of a disc-shaped reservoir for storing disinfectant. As illustrated in FIGS. 1-3 the apparatus for storing disinfectant includes a disc-shaped reservoir 100. The disc-shaped reservoir 100 may form a circular or oval shape. In other embodiments, the reservoir 100 may form a hectogon shape, cube shape, sphere shape, or any other similar shape to accommodate the application of a sewage-mixing tank. The disc-shaped reservoir 100 may be manufactured from a polymer material such as natural polymer, synthetic polymer, linear polymers, or any other similar polymers or plastic material. In one or more embodiments, the disc-shaped reservoir 100 is hollow. That is, the disc-shaped reservoir 100 has an internal volume (not illustrated for clarity) for housing disinfectant agents, such as chlorine, or other similar solutions that will be dispensed into a wastewater effluent storage-mixing tank.

For integrity and structural benefits, the disc-shaped reservoir 100 has a surface section 102 that forms a dome-like shape. That is, the surface section 102 forms an arc that extends upwards from one side of the surface section 102, and then, downward to the other side of the surface section 102. The structural design of the surface section 102 allows for the emptying of the disc-shape reservoir 100 during contamination events that may occur internally (i.e., within the internal volume) within the disc-shaped reservoir 100. As illustrated in FIGS. 1 and 2, the surface section 102 may be integrally coupled to and positioned substantially perpendicular to a wall section 104. Further, as illustrated more clearly in FIG. 1, the disc-shaped reservoir 100 has a bottom section 106 that is integrally coupled to and positioned substantially perpendicular to the wall section 104.

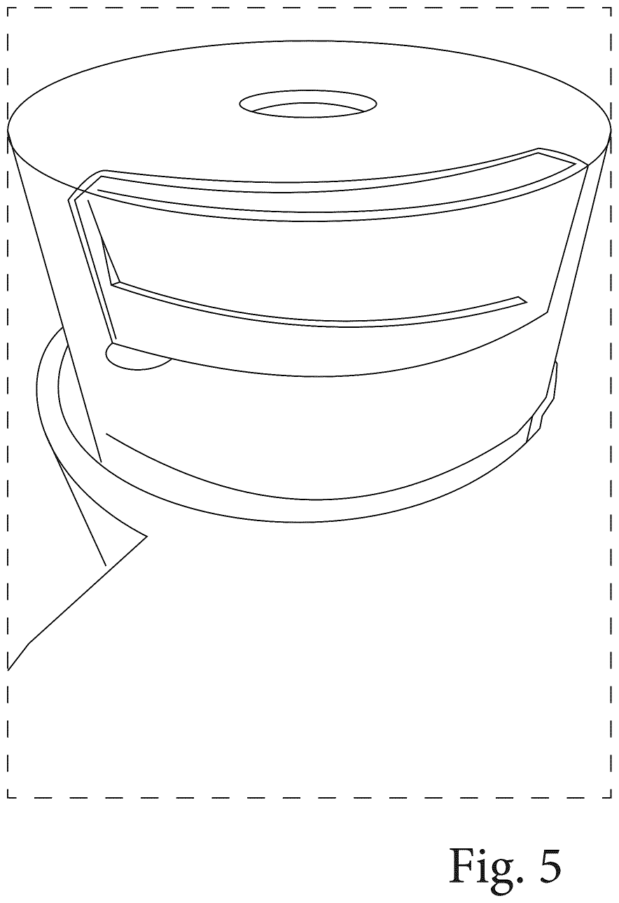

In one or more embodiments, the disc-shaped reservoir 100 has a cylindrical filler neck 108 coupled to the surface section 102. The cylindrical filler neck 108 may be integrally coupled to the surface section 102. The cylindrical filler neck 108 serves as a conduit by which disinfectant agent can enter the internal volume of the disc-shaped reservoir 100. In one or more embodiments, as further described in reference to FIG. 5, the cylindrical filler neck 108 has a twist lock section 110 such that a cap is couplable to the twist lock section 110.

As more clearly illustrated in FIGS. 2 and 3, the disc-shaped reservoir 100 may include a series of reveals integrally coupled to the wall section 104. That is, the reveals (similar to niches) are recesses or cavities constructed in the thickness of a wall creating a half-circle cavity for securing the disc-shaped reservoir 100 to a wastewater treatment tank access riser. More specifically, the disc-shaped reservoir 100 includes a first reveal 112 integrally coupled to the wall section 104. In one or more embodiments, the disc-shaped reservoir 100 includes a second reveal 114 integrally coupled to the wall section 104 and positioned substantially 90 degrees from the first reveal 112. For example, in an x-y coordinate plane configuration, if the first reveal 112 is positioned substantially on the y-axis of the plane, the second reveal 114 would be positioned substantially on the x-axis of the plane.

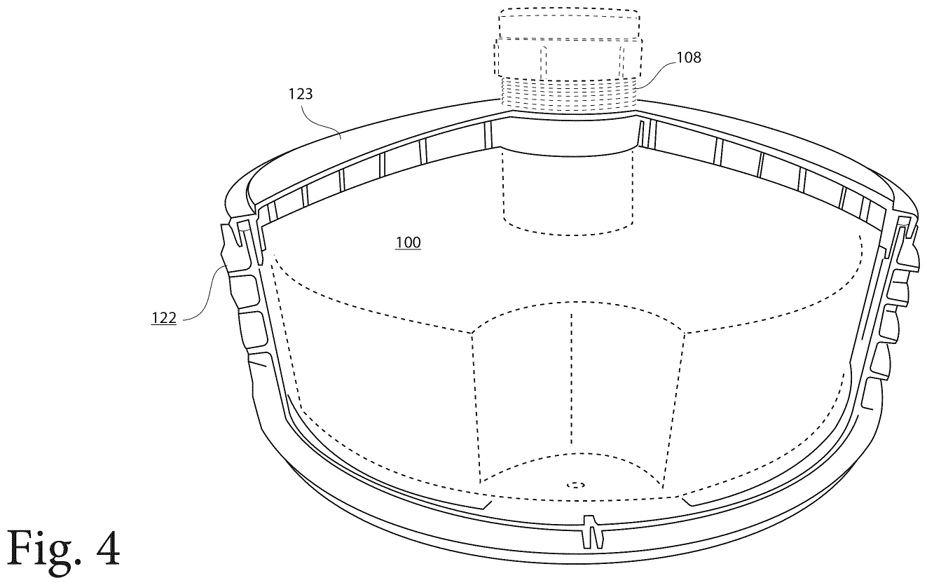

As further illustrated in FIGS. 2 and 3, the disc-shaped reservoir 100 may include a third reveal 116 integrally coupled to the wall section 104 and positioned substantially 180 degrees from the first reveal 112 and substantially 90 degrees from the second reveal 114. For example, in the x-y coordinate plane configuration, if the first reveal 112 is positioned substantially on the x-axis plane at 0 degrees, then the third reveal 116 would also be placed on the x-axis plane, except it will be at 180 degrees on the x-axis. In one or more embodiments, the disc-shaped reservoir 100 includes a fourth reveal 118 integrally coupled to the wall section 104 and positioned substantially 90 degrees from the third reveal 116 and 270 degrees from the first reveal 112. As illustrated in FIG. 3, each reveal may include a pit (i.e., hole) or slot in the bottom section 106 to aid in securing the disc-shaped reservoir 100 to a wastewater treatment tank access riser. As further illustrated in FIGS. 1-3, the disc-shaped reservoir 100 forms a circle shape. That is, the disc-shaped reservoir 100 has a diameter (illustrated by reference number 120) that may range in measurement of between ten inches to 25 inches or with the preferred measurement of 19.750 inches in diameter which is described further in reference to FIG. 4.

FIG. 4 is a cut-out perspective view of a disc-shaped reservoir for storing disinfectant coupled to a wastewater treatment tank access riser. As illustrated in FIG. 4, a wastewater treatment tank access riser 122 is shown in solid black lines, whereas for clarity the disc-shaped reservoir 100 is shown in dashed lines. Additionally, a riser cover 123 (also illustrated in solid lines) is coupled to the wastewater treatment tank access riser 122. A wastewater treatment tank access riser 122 is a device that is coupled to the opening of a wastewater storage-mixing tank so that above ground access to the wastewater storage-mixing tank is more accessible. As described in reference to FIGS. 1-3, the disc-shaped reservoir 100 has a diameter that is complimentary to the wastewater storage-mixing tank access riser 122 such that the disc-shaped reservoir 100 can be fully secured to the wastewater storage-mixing tank access riser 122. This extra level of security prevents individuals from mistakenly falling into the storage-mixing tank, thus acting like a secondary containment such that entry of an unauthorized entity into the wastewater storage-mixing tank is restricted. Further, although not illustrated for clarity, the disc-shaped reservoir 100 diameter 120 is such that the first, second, third, and fourth reveals compliment a series of retaining tabs (not illustrated for clarity) coupled to the wastewater storage-mixing tank access riser 122. In one or more embodiments, bolts or clamps secure the retaining tabs to the respective reveals, thus adding another level of security to the storage-mixing tank. In one or more embodiments, the cylindrical filler neck 108 extends through an access point (i.e., hole in the riser cover 123) so that the disc-shaped reservoir 100 may be refilled with liquid disinfectant without removing the riser cover 123.

FIG. 5 is a perspective view of the disc-shaped reservoir twist lock section. As described above, the twist lock section 104 has a mechanism that allows a cap to securely snap to the twist lock section 104. Specifically, as illustrated in FIG. X, the twist lock section 110 has a sectional cut-out forming a downward spiral rim. Positioned towards the top of the spiral is a notch that allows the cap to position and snap to the twist lock section 104.

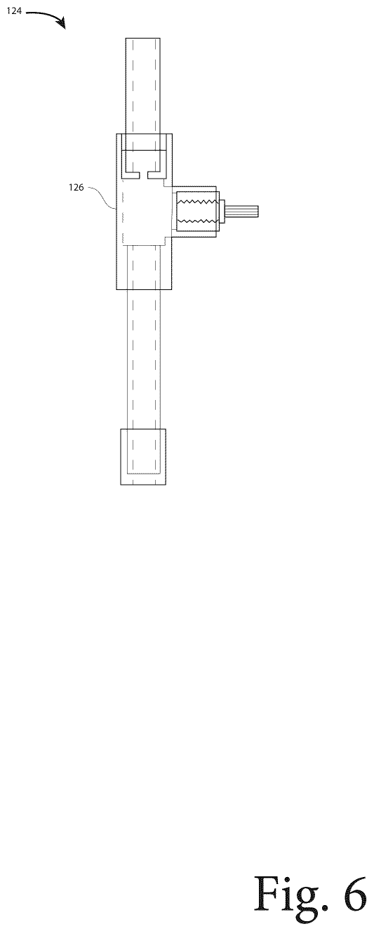

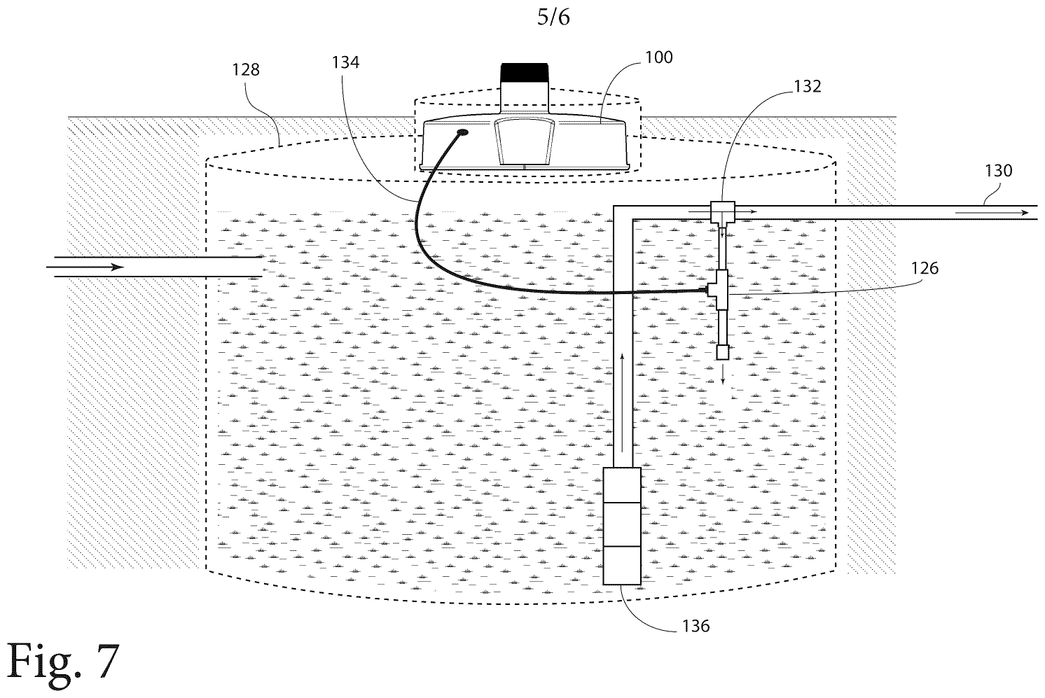

FIG. 6 is a cross-sectional view of a disinfectant dispensing system. FIG. 7 is a semi-translucent profile view of a wastewater storage-mixing tank with disinfectant dispensing system for septic systems having a wastewater storage-mixing tank access riser, a disc-shaped reservoir for storing disinfectant, a disinfectant dispensing system, and a pump. As illustrated in FIG. 6, the apparatus and system may include a disinfectant dispensing system 124. In one or more embodiments, the disinfectant dispensing system 124 may include a combination of pipes having different diameters (i.e., constricted sections) and flow rate creating a venturi 126. A venturi controls the speed and flow of a fluid, by constricting the fluid in a cone-shaped tube. In the restriction, the fluid must increase its velocity, thus reducing its pressure and producing a partial vacuum. As fluid leaves the constriction, its pressure increases back to the ambient or pipe level.

As illustrated in FIG. 7, the disinfectant dispensing system 124 is placed within a storage-mixing tank 128 and coupled to an effluent discharge pipe 130. In one or more embodiments, a pipe tee fitting 132 is coupled to the effluent discharge pipe 130 and to the venturi 126 such that fluid can flow through the effluent discharge pipe 130 and the venturi 126. Additionally, the venturi 126 has a hole that allows the treated effluent to be dispensed back into the storage-mixing tank 128. The hole is placed opposite the pipe tee fitting 132 towards the bottom of the venturi 126 which allows the disinfected effluent to enter the wastewater storage-mixing tank 128. As further illustrated in FIG. 7, a disinfectant supply tubing 134 is fluidly coupled to the disc-shaped reservoir 100 and to the venturi 126. In one or more embodiments, a pump 136 is coupled to the effluent discharge pipe 130 to facilitate the circulation of the disinfectant within the treated effluent. The pump 136 is placed deep inside the wastewater storage-mixing tank 128. When the pump 136 is engaged, negative pressure is created within the venturi 126 and the disinfectant dispensing system 124 such that a liquid disinfectant stored in the disc-shaped reservoir 100 is cycled through the disinfectant dispensing system 124, the effluent discharge pipe 130, and the wastewater storage-mixing tank 128.

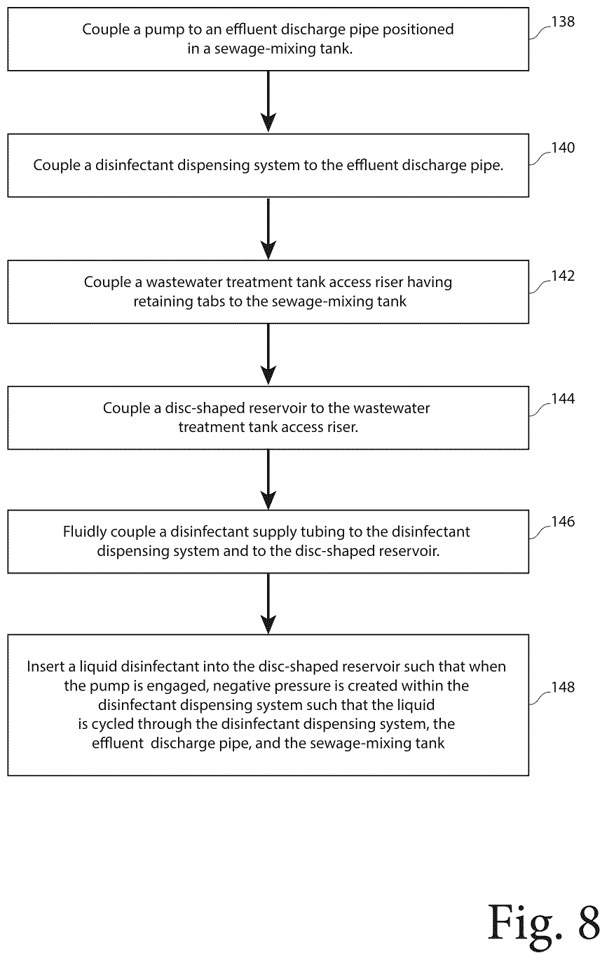

FIG. 8 is a flow chart illustrating a method for implementing and operating a wastewater treatment system for septic systems. In operation, the method may include coupling a pump (such as pump 136) to an effluent discharge pipe (such as effluent discharge pipe 130) positioned in a wastewater storage-mixing tank (such as wastewater storage-mixing tank 128) (block 138). A disinfectant dispensing system (such disinfectant dispensing system 124) is coupled to the effluent discharge pipe (such as effluent discharge pipe 130) (block 140). A wastewater treatment tank access riser (such as wastewater treatment tank access riser 122) having retaining tabs is coupled to the wastewater storage-mixing tank (such as wastewater storage-mixing tank 128) (block 142). A disc-shaped reservoir (such as disc-shaped reservoir 100) is coupled to the wastewater treatment tank access riser (such as wastewater treatment tank access riser 122) (block 144). A disinfectant supply tubing (such as disinfectant supply tubing 134) is fluidly coupled to the disinfectant dispensing system (such as disinfectant dispensing system 124) and to the disc-shaped reservoir (such as disc-shaped reservoir 100) (block 146). A liquid disinfectant is inserted into the disc-shaped reservoir (such as disc-shaped reservoir 100) such that when the pump (such as pump 136) is engaged, negative pressure is created within the disinfectant dispensing system (such as disinfectant dispensing system 124) such that the liquid is cycled through the disinfectant dispensing system (such as disinfectant dispensing system 124), the effluent discharge pipe (such effluent discharge pipe 130), and the wastewater storage-mixing tank (such as wastewater storage-mixing tank 128).

In one aspect the apparatus includes a disc-shaped reservoir having an internal volume. A surface section is integrally coupled to and positioned substantially perpendicular to a wall section. A bottom section is integrally coupled to and positioned substantially perpendicular to the wall section. A cylindrical filler neck is coupled to the surface section. A first reveal is integrally coupled to the wall section. A second reveal is integrally coupled to the wall section and positioned substantially 90 degrees from the first reveal. A third reveal is integrally coupled to the wall section and positioned substantially 180 degrees from the first reveal and substantially 90 degrees from the second reveal. A fourth reveal is integrally coupled to the wall section and positioned substantially 90 degrees from the third reveal and 270 degrees from the first reveal.

Implementation may include one or more of the following. The disc-shaped reservoir may include a disinfectant dispensing system. The disinfectant dispensing system may include a disinfectant supply tubing fluidly coupled to the disc-shaped reservoir. A venturi may be coupled to the disinfectant supply tubing. A pipe tee fitting may be coupled to the venturi and may be couplable to an effluent discharge pipe. The cylindrical filler neck may include incorporate a twist lock section such that a cap may be couplable to the twist lock section. The surface section may form a dome-shape such that it may facilitate the emptying of the disc-shaped reservoir during contamination events within the disc-shaped reservoir. The surface section may form a dome-shape such that it may provide additional structural integrity to the surface region of the disc-shaped reservoir. The disc-shaped reservoir may have a diameter such that that the first, second, third, and fourth reveals may compliment a series of retaining tabs coupled to the wastewater treatment tank access riser. The disc-shaped reservoir may be secured to the wastewater treatment tank access riser retaining tabs wherein a secondary containment is formed such that entry of an unauthorized entity into the wastewater treatment tank is restricted.

In one aspect the system may include a storage-mixing tank having an effluent discharge pipe. A wastewater treatment tank access riser is coupled to a surface section of the storage-mixing tank. A riser cover having an access point is coupled to the wastewater treatment tank access riser. A disc-shaped reservoir is coupled to the wastewater treatment tank access riser. The disc-shaped reservoir has an internal volume. A surface section is integrally coupled to and positioned substantially perpendicular to a wall section. A bottom section is integrally coupled to and positioned substantially perpendicular to the wall section. A cylindrical filler neck is coupled to the surface section. A first reveal is integrally coupled to the wall section. A second reveal is integrally coupled to the wall section and positioned substantially 90 degrees from the first reveal. A third reveal is integrally coupled to the wall section and positioned substantially 180 degrees from the first reveal and substantially 90 degrees from the second reveal. A fourth reveal is integrally coupled to the wall section and positioned substantially 90 degrees from the third reveal and 270 degrees from the first reveal. A pump is coupled to the effluent discharge pipe. A disinfectant dispensing system is positioned in the wastewater storage-mixing tank and the wastewater treatment tank access riser and coupled to the effluent discharge pipe and the pump.

Implementation may include one or more of the following. The disc-shaped reservoir may include a disinfectant dispensing system. The disinfectant dispensing system may include a disinfectant supply tubing fluidly coupled to the disc-shaped reservoir. A venturi may be coupled to the disinfectant supply tubing. A pipe tee fitting may be coupled to the venturi and to the effluent discharge pipe. The cylindrical filler neck may include a twist lock section such that a cap may be couplable to the twist lock section. The surface section may form a dome-shape such that it may facilitate the emptying of the disc-shaped reservoir during contamination events within the disc-shaped reservoir. The surface section may form a dome-shape such that it may provide additional structural integrity to the surface region of the disc-shaped reservoir. The disc-shaped reservoir may have a diameter such that that the first, second, third, and fourth reveals may compliment a series of retaining tabs coupled to the wastewater treatment tank access riser. The disc-shaped reservoir may be secured to the wastewater treatment tank access riser retaining tabs wherein a secondary containment is formed such that entry of an unauthorized entity into the wastewater treatment tank is restricted.

In one aspect, the method includes coupling a pump to an effluent discharge pipe positioned in a wastewater storage-mixing tank. A disinfectant dispensing system is coupled to the effluent discharge pipe. A wastewater treatment tank access riser having retaining tabs is coupled to the wastewater storage-mixing tank. A disc-shaped reservoir is coupled to the wastewater treatment tank access riser. The disc-shape reservoir has an internal volume. A surface section is integrally coupled to and positioned substantially perpendicular to a wall section. A bottom section is integrally coupled to and positioned substantially perpendicular to the wall section. A cylindrical filler neck is coupled to the surface section. A first reveal is integrally coupled to the wall section. A second reveal is integrally coupled to the wall section and positioned substantially 90 degrees from the first reveal. A third reveal is integrally coupled to the wall section and positioned substantially 180 degrees from the first reveal and substantially 90 degrees from the second reveal. A fourth reveal is integrally coupled to the wall section and positioned substantially 90 degrees from the third reveal and 270 degrees from the first reveal. A disinfectant supply tubing is fluidly coupled to the disinfectant dispensing system and to the disc-shaped reservoir. A liquid disinfectant is inserted into the disc-shaped reservoir such that when the pump is engaged, negative pressure is created within the venturi and the disinfectant dispensing system such that the liquid disinfectant is cycled through the disinfectant dispensing system, the effluent discharge pipe, and the wastewater storage-mixing tank.

Implementation may include one or more of the following. The disc-shaped reservoir may include a disinfectant dispensing system. The disinfectant dispensing system may include a disinfectant supply tubing fluidly coupled to the disc-shaped reservoir. A venturi may be coupled to the disinfectant supply tubing. A pipe tee fitting may be coupled to the venturi and to the effluent discharge pipe. The cylindrical filler neck may include a twist lock section such that a cap may be couplable to the twist lock section. The surface section may form a dome-shape such that it may facilitate the emptying of the disc-shaped reservoir during contamination events within the disc-shaped reservoir. The surface section may form a dome-shape such that it may provide additional structural integrity to the surface region of the disc-shaped reservoir. The disc-shaped reservoir may have a diameter such that that the first, second, third, and fourth reveals may compliment a series of retaining tabs coupled to the wastewater treatment tank access riser. The disc-shaped reservoir may be secured to the wastewater treatment tank access riser retaining tabs wherein a secondary containment is formed such that entry of an unauthorized entity into the wastewater storage-mixing tank is restricted.

The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus for dispensing disinfectant comprising:
a disc-shaped reservoir having:
an internal volume;
a surface section integrally coupled to and positioned substantially perpendicular to a wall section; and
a bottom section integrally coupled to and positioned substantially perpendicular to the wall section;
a cylindrical filler neck coupled to the surface section;
a first reveal integrally coupled to the wall section;
a second reveal integrally coupled to the wall section and positioned substantially 90 degrees from the first reveal;
a third reveal integrally coupled to the wall section and positioned substantially 180 degrees from the first reveal and substantially 90 degrees from the second reveal; and
a fourth reveal integrally coupled to the wall section and positioned substantially 90 degrees from the third reveal and 270 degrees from the first reveal.

2. The apparatus of claim 1 wherein the disc-shaped reservoir comprises:
a disinfectant dispensing system having:
a disinfectant supply tubing fluidly coupled to the disc-shaped reservoir;
a venturi coupled to the disinfectant supply tubing; and
a pipe tee fitting coupled to the venturi and couplable to an effluent discharge pipe.

3. The apparatus of claim 1 wherein the cylindrical filler neck comprises a twist lock section such that a cap is couplable to the twist lock section.

4. The apparatus of claim 1 wherein the surface section forms a dome-shape such that it facilitates the emptying of the disc-shaped reservoir during contamination events within the disc-shaped reservoir.

5. The apparatus of claim 1 wherein the surface section forms a dome-shape such that it provides additional structural integrity to the surface region of the disc-shaped reservoir.

6. The apparatus of claim 1 wherein the disc-shaped reservoir has a diameter such that the first, second, third, and fourth reveals compliment a series of retaining tabs coupled to a wastewater treatment tank access riser.

7. The apparatus of claim 6 wherein when the disc-shaped reservoir is secured to the wastewater treatment tank access riser retaining tabs a secondary containment is formed such that entry of an unauthorized entity into the wastewater treatment tank is restricted.

8. A wastewater treatment system for septic systems comprising:
a storage-mixing tank having an effluent discharge pipe;
a wastewater treatment tank access riser coupled to a surface section of the storage-mixing tank;
a riser cover having an access point coupled to the wastewater treatment tank access riser;
a disc-shaped reservoir coupled to the wastewater treatment tank access riser; the disc-shaped reservoir having:
an internal volume,
a surface section integrally coupled to and positioned substantially perpendicular to
a wall section, and
a bottom section integrally coupled to and positioned substantially perpendicular to the wall section;
a cylindrical filler neck integrally coupled to the surface section and extending through the riser cover access point;
a first reveal integrally coupled to the wall section;
a second reveal integrally coupled to the wall section and positioned substantially 90 degrees from the first reveal;
a third reveal integrally coupled to the wall section and positioned substantially 180 degrees from the first reveal and substantially 90 degrees from the second reveal; and
a fourth reveal integrally coupled to the wall section and positioned substantially 90 degrees from the third reveal and 270 degrees from the first reveal;
a pump coupled to the effluent discharge pipe;
a disinfectant dispensing system positioned in the storage-mixing tank and the wastewater treatment tank access riser and coupled to the effluent discharge pipe and the pump.

9. The wastewater treatment system of claim 8 wherein the disc-shaped reservoir comprises:
a disinfectant dispensing system having:
a disinfectant supply tubing fluidly coupled to the disc-shaped reservoir;
a venturi coupled to the disinfectant supply tubing; and
a pipe tee fitting coupled to the effluent discharge pipe and the venturi.

10. The wastewater treatment system of claim 8 wherein the cylindrical filler neck comprises a twist lock section such that a cap is couplable to the twist lock section.

11. The wastewater treatment system of claim 8 wherein the surface section forms a dome-shape such that it facilitates the emptying of the disc-shaped reservoir during contamination events within the disc-shaped reservoir.

12. The wastewater treatment system of claim 8 wherein the surface section forms a dome-shape such that it provides additional structural integrity to the surface region of the disc-shaped reservoir.

13. The wastewater treatment system of claim 8 wherein the disc-shaped reservoir has a diameter such that the first, second, third, and fourth reveals compliment a series of retaining tabs coupled to a wastewater treatment tank access riser.

14. The wastewater treatment system of claim 13 wherein when the disc-shaped reservoir is secured to the wastewater treatment tank access riser retaining tabs a secondary containment is formed such that entry of an unauthorized entity into the wastewater treatment tank is restricted.

15. A method for dispensing disinfectant comprising:
Coupling a pump to an effluent discharge pipe positioned in a storage-mixing tank;
coupling a disinfectant dispensing system to the effluent discharge pipe;
coupling a wastewater treatment tank access riser having retaining tabs to the storage-mixing tank;
coupling a disc-shaped reservoir to the wastewater treatment tank access riser, the disc-shaped reservoir having:
an internal volume;
a surface section integrally coupled to and positioned substantially perpendicular to a wall section; and
a bottom section integrally coupled to and positioned substantially perpendicular to the wall section;
a cylindrical filler neck integrally coupled to the surface section;
a first reveal integrally coupled to the wall section;
a second reveal integrally coupled to the wall section and positioned substantially 90 degrees from the first reveal;
a third reveal integrally coupled to the wall section and positioned substantially 180 degrees from the first reveal and substantially 90 degrees from the second reveal; and
a fourth reveal integrally coupled to the wall section and positioned substantially 90 degrees from the third reveal and 270 degrees from the first reveal, such that when the disc-shaped reservoir is inserted into the wastewater treatment tank access riser the reveals are secured to the retaining tabs;
fluidly coupling a disinfectant supply tubing to the disinfectant dispensing system and to the disc-shaped reservoir;
inserting a liquid disinfectant into the disc-shaped reservoir such that when the pump is engaged, negative pressure is created within the venturi and the disinfectant dispensing system such that the liquid disinfectant is cycled through the disinfectant dispensing system, the effluent discharge pipe, and the sewage-mixing tank.

16. The method of claim 13 wherein the disinfectant dispensing recycling system comprises:
a venturi coupled to the disinfectant supply tubing; and
a pipe tee fitting coupled to the effluent discharge pipe and the venturi.

17. The method of claim 13 wherein the cylindrical filler neck comprises a twist lock section such that a cap is couplable to the twist lock section.

18. The method of claim 13 wherein the surface section forms a dome-shape such that it facilitates the emptying of the disc-shaped reservoir during contamination events within the disc-shaped reservoir.

19. The method of claim 13 wherein the surface section forms a dome-shape such that it provides additional structural integrity to the surface region of the disc-shaped reservoir.

20. The method of claim 13 wherein the reservoir has a diameter such that the first, second, third, and fourth reveals compliment a series of retaining tabs coupled to the wastewater treatment tank access riser.

21. The method of claim 20 wherein when the disc-shaped reservoir is secured to the wastewater treatment tank access riser retaining tabs a secondary containment is formed such that entry of an unauthorized entity into the wastewater treatment tank is restricted.
